(19) United States
(12) Patent Application Publication
(10) Pub. No.: US 2010/0232663 A1
(43) Pub. Date: Sep. 16, 2010

(54) COMPUTED TOMOGRAPHY RECONSTRUCTION FOR TWO TILTED CIRCLES

(75) Inventor: Claas Bontus, Hamburg (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/377,910

(22) PCT Filed: Jul. 24, 2007
(86) PCT No.: PCT/US07/74204

§ 371 Date: Feb. 18, 2009

Related U.S. Application Data
(60) Provisional application No. 60/823,104, filed on Aug. 22, 2006.

(51) Int. Cl. G06K 9/00

(52) U.S. Cl. 382/131

(57) ABSTRACT

A computed tomography apparatus (10) acquires projection data along a trajectory which includes first (50) and second (50′) tilted circles. A reconstructor (22), includes a differentiator (24), a filter (26), and a backprojector (27). The filter (26) applies a filter function which varies according to a location (x) which is to be reconstructed. The parameters of the filter function are selected so that the reconstructor (22) performs an exact filtered backprojection.

The present application relates to computed tomography (CT). It finds particular application to x-ray CT in medicine. It also finds application to article and security inspection, non-destructive testing, pre-clinical imaging, and other situations in which CT data can provide useful information about the characteristics of an object.

CT scanners have proven to be invaluable in medical and other applications in which it is necessary to obtain information about the internal structure or function of an object. In medical imaging, for example, CT scanners are widely used to provide images of and other information about the internal characteristics of human patients. A relatively recent trend has been the adoption of multi-slice CT, as increasing the axial coverage of a CT scanner can have a number of advantages, including an improved ability to scan moving portions of the anatomy, shorter scan times, and improved scanner throughput.

As the number or rows or slices increases, circular scanning trajectories become increasingly attractive. One issue with such circular trajectories, however, is the incompleteness of the acquired data set. One solution to this problem is the use of an additional trajectory segment which provides the missing data. Because only low frequency components are missing from the reconstruction result of the circle orbit, it is possible to obtain the additional segment at a relatively low dose. Examples of trajectories including an additional segment include circle and line orbits and two tilted circles.

While the use of additional segments can provide the data missing from a circular trajectory, there remains room for improvement. More particularly, it remains desirable to reconstruct relatively higher quality images with a reasonable amount of computing effort.

Aspects of the present application address these matters, and others.

In accordance with one aspect, an apparatus includes a differentiator, a filter, and a backprojector. The differentiator differentiates computed tomography projection data acquired along a trajectory which includes first and second tilted circles. The filter filters the differentiated data, with the number and direction of the applied filters varying as a function of an object location which is to be reconstructed. The backprojector backprojects the filtered data.

According to another aspect, a computed tomography method includes differentiating computed tomography projection data acquired along first and second tilted circles, filtering the differentiated data, and backprojecting the filtered data. The number and direction of the applied filters varies based on a projection of an object location which is to be reconstructed.

According to another aspect, a computer readable storage medium contains instructions which, when carried out by a computer processor, cause a computer to carry out a computed tomography reconstruction method. The method includes filtering differentiated first cone beam projection data acquired along a first circular trajectory, filtering differentiated second cone beam projection data acquired along a second circular trajectory, and backprojecting the filtered data to generate volumetric data indicative of an object under examination. The second circular trajectory is tilted relative to the first circular trajectory, and the reconstruction is an exact reconstruction.

According to another aspect, an apparatus includes means for acquiring x-ray computed tomography projection data along a trajectory which includes first and second tilted circles, means for performing an exact reconstruction of the acquired projection data. The means for performing includes means for differentiating projection data acquired along parallel rays, means for filtering the differentiated data, wherein a number of the applied filters varies based on a location of the means for acquiring and a location to be reconstructed, and means for backprojecting the filtered data. The apparatus also includes means for generating a human readable image indicative of the reconstructed data.

According to another aspect, a method of reconstructing images from data provided by at least a first two dimensional detector includes the steps of scanning an object so as to acquire projection data along a trajectory which includes first and second tilted circles with at least a first two dimensional detector and cone beam projections and reconstructing an exact image of the scanned object with an FBP algorithm.

Still further aspects of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

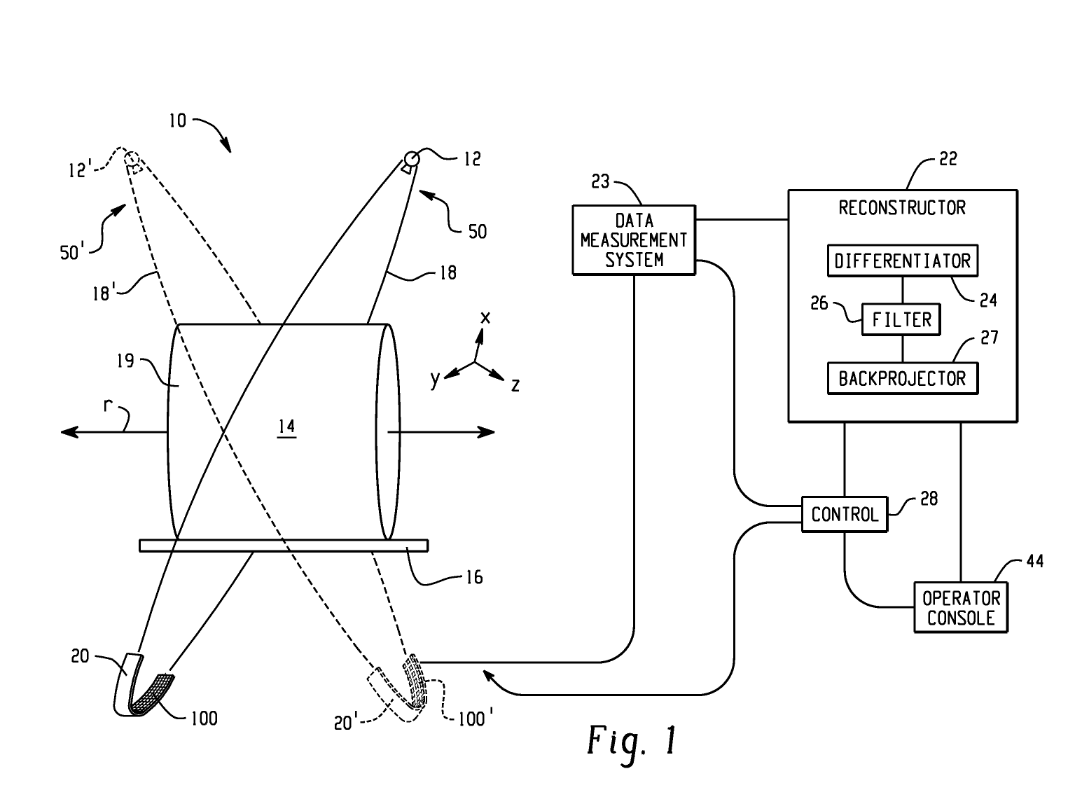

FIG. 1 depicts an x-ray CT scanner.

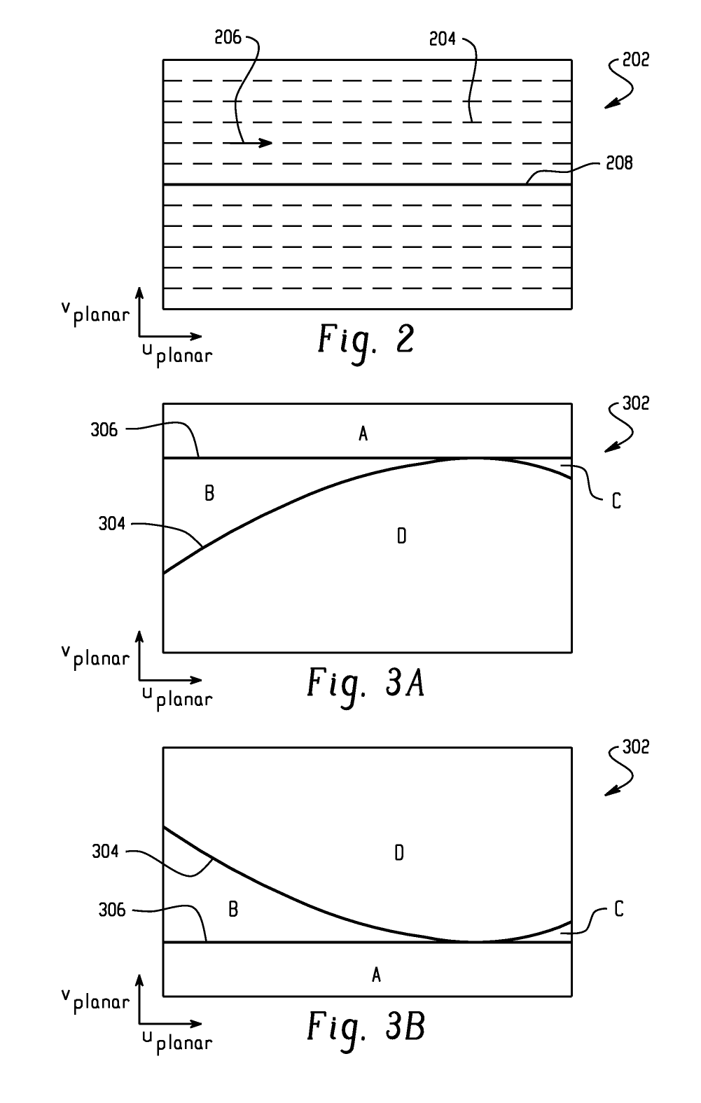

FIG. 2 depicts filter lines applied to a first virtual detector.

FIGS. 3A and 3B depict a second virtual detector.

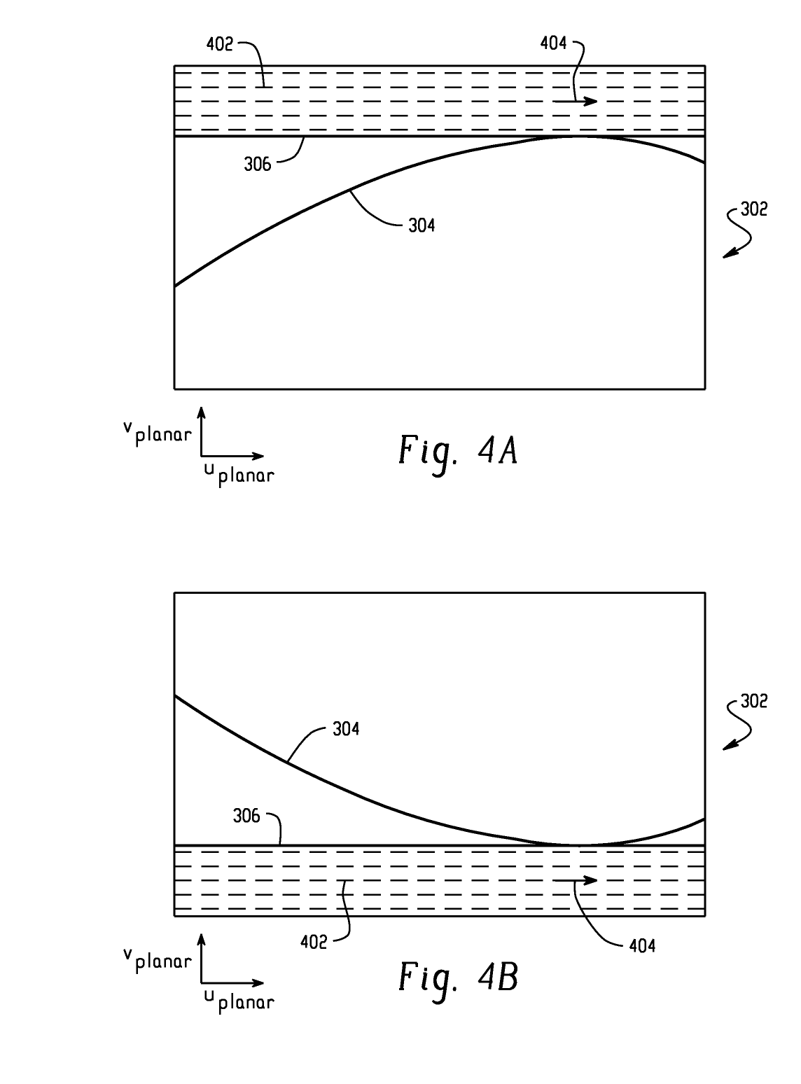

FIGS. 4A and 4B depict a set of filter lines applied to the second virtual detector at respective first and second positions on a second circle.

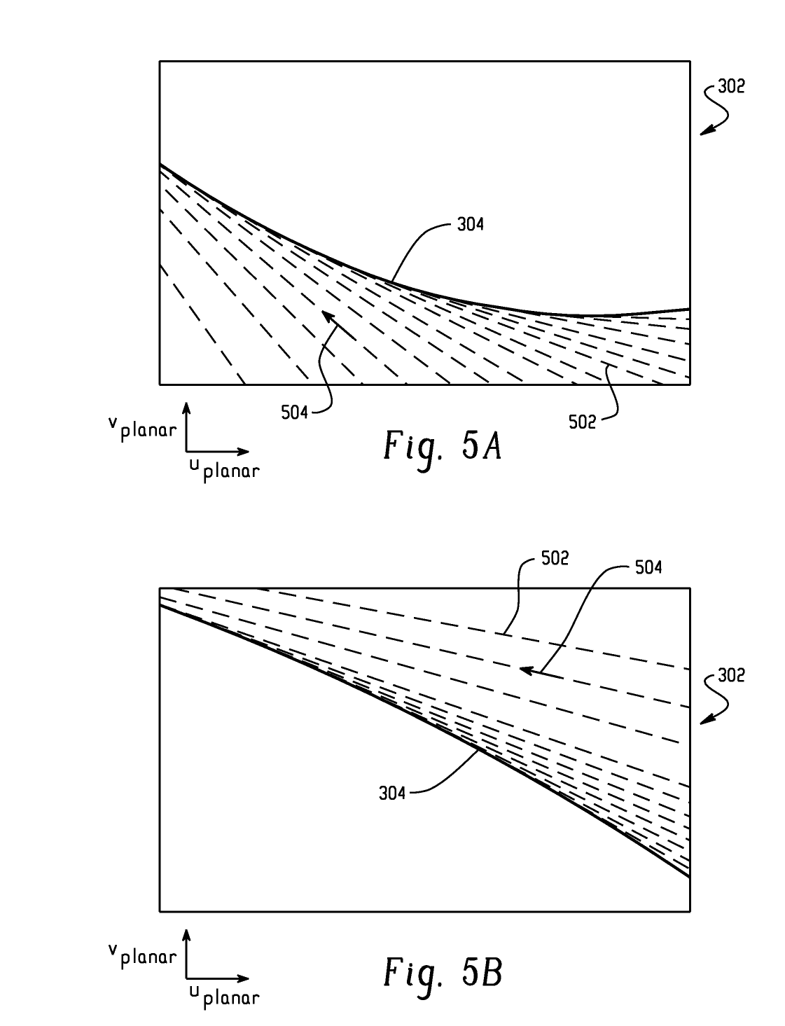

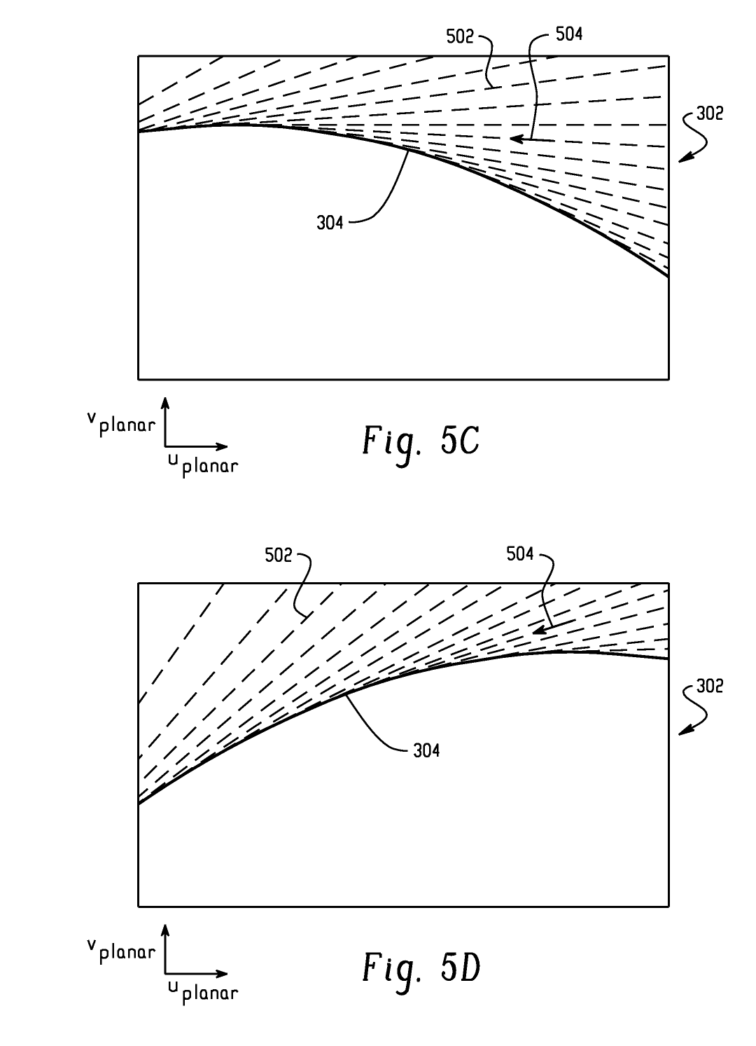

FIGS. 5A, 5B, 5C and 5D depict filter lines relative to the second virtual detector at respective first, second, third, and fourth positions on the second circle.

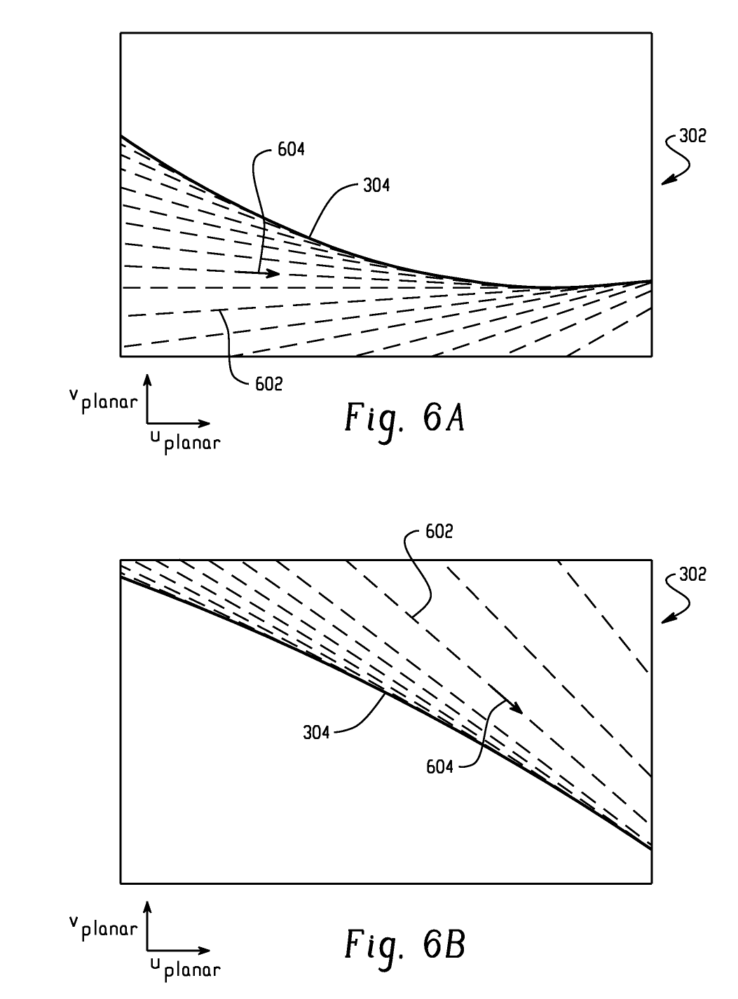

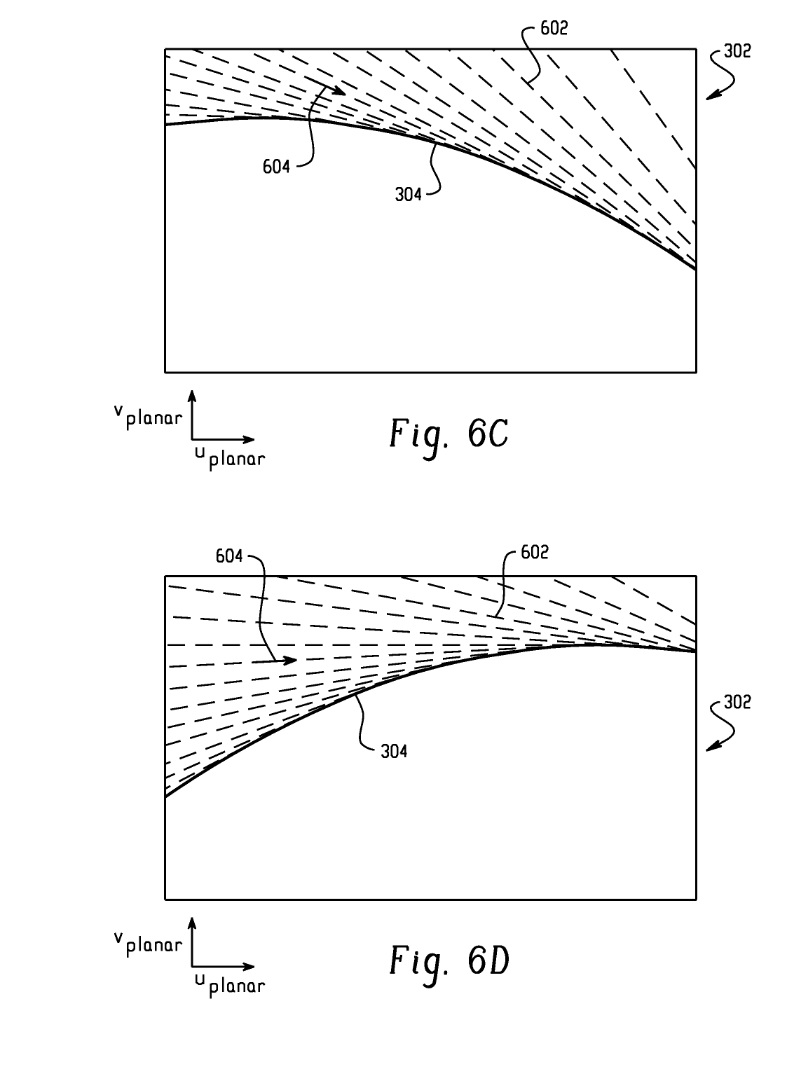

FIGS. 6A, 6B, 6C and 6D depict filter lines relative to the second virtual detector at respective first, second, third, and fourth positions on the second circle.

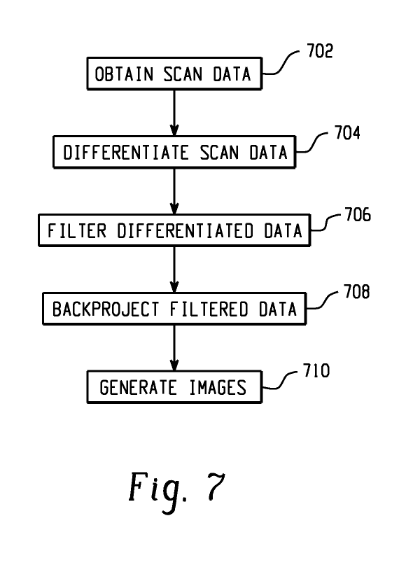

FIG. 7 depicts an imaging method.

With reference to FIG. 1, a CT scanner 10 includes a rotating gantry 18 which rotates about an axis of rotation r. The gantry 18 supports an x-ray source 12 such as an x-ray tube which generates a generally conical radiation beam. The gantry 18 also supports an x-ray sensitive detector 20 which subtends an angular arc on the opposite side of an examination region 14. As illustrated, the detector 20 is a multi-slice detector which includes multiple rows or slices of detector elements 100. Flat panel, area, or other detector 20 configurations, as well as fourth generation or other system geometries, may also be implemented. An object support 16 such as a couch supports the patient or other object 19 under examination in the examination region 14.

The rotating gantry 18 and object 19 are relatively movable so as to acquire projection data according to a scanning trajectory which includes first 50 and second 50′ circles, which circles are tilted relative to each other. For clarity of illustration, an exemplary first circle 50 is shown in FIG. 1 in solid line, while the second circle 50′ is shown in phantom. The trajectory can be obtained, for example, by tilting the gantry 20, tilting the support 16, or translating the x-ray source 12 and/or the detector 20, either alone or in combination, as the source 12 rotates about the examination region 14. The source 12 and detector 20 may also remain at a constant angular position while the object 19 is rotated.

A data measurement system 23 preferably located at or near the rotating gantry 18 includes signal conditioning, analog to digital conversion, multiplexing, and like functionality for further processing the signals from the detector 20. A controller 28 coordinates the relative motion of the gantry 18 and/or the object 19 so as to provide the desired trajectory, as well as the other parameters as necessary to carry out a desired scan protocol.

A reconstructor 22 reconstructs the signals from the detector 20 to generate volumetric data indicative of the object 19. The reconstructor 22 includes a differentiator 24 which differentiates the projection data, a filter 26 which filters the differentiated data, and a backprojector 27 which backprojects the filtered data. As will be described further below, the reconstructor 22 carries out an exact, filtered backprojection (FBP) of projection data acquired using a scan trajectory which includes the two (2) tilted circles 50, 50′.

A general purpose computer serves an operator console 44. The console 44 includes a human readable output device such as a monitor or display and an input device such as a keyboard and mouse. Software resident on the console allows the operator to control the operation of the scanner 10 by establishing desired scan protocols, initiating and terminating scans, viewing and otherwise manipulating the volumetric image data, and otherwise interacting with the scanner 10, for example through a graphical user interface (GUI).

The reconstructor 22 will now be described in additional detail. For the purposes of the following discussion, and as illustrated in FIG. 1, the first circle 50 will be assumed to be located in the xy-plane, with the second circle 50′ tilted about the y axis. Using these conventions, the first 50 and second 50′ circles can be parameterized as follows:

$${y}_{1} ( s ) = ( \begin{matrix}R cos s \\ R sin s \\ 0\end{matrix} ) , {y}_{2} ( s ) = ( \begin{matrix}R cos s cos λ \\ R sin s \\ - R cos s sin λ\end{matrix} ) \qquad Equation 1$$

where y₁(s) and y₂(s) represent the position of the source 12 relative to the respective first 50 and second 50′ circles, s represents the angular position of the source 12, λ corresponds to the tilt angle of the circles, and R corresponds to the distance from the source 12 to the rotation axis r.

For the various positions y(s) along the trajectory, the measured projection data can be expressed as the line integral of the radiation attenuation along each of a plurality of rays or paths through the object:

$${D}_{f} ( y ( s ) , θ ) = {\int }_{0}^{∞} d lf ( y + l θ ) . \qquad Equation 2$$

where 0 is a unit vector which describes the direction of the rays and f(y+lθ) is the object function.

With continuing reference to FIG. 1, the differentiator 24 differentiates the projection data along parallel rays:

$${D}_{f}^{′} ( y ( s ) , θ ) = \frac{\partial {D}_{f} ( y ( s ) , θ = const . )}{\partial s} \qquad Equation 3$$

For the purpose of the above differentiation, it will be understood that parallel rays are those that originate from different source trajectory but intersect the detector 20 in the same row. In one implementation, the differentiation is performed using a Fourier filter, although other suitable differentiation techniques may be used.

The filter 26 filters the differentiated data using a 1/sin γ filter. The number N_{f} of the applied filters and the direction eₙ of the applied filters varies as a function of the source position s and the object voxel or location x which is to be reconstructed. For a given source position and object location, a unit vector β(s,x) pointing from the source s to the object location x can be defined as follows:

$$β ( s , x ) = \frac{x - y ( s )}{\vert x - y ( s ) \vert} \qquad Equation 4$$

The directions of the filter vector(s), which are described by the unit vector eₙ, is perpendicular to the vector β(s,x).

The filtering operation can be described as follows:

$$P ( s , β ) = {\sum }_{n = 1}^{{N}_{f}} {μ}_{n} {\int }_{- π}^{π} \frac{d γ}{sin γ} {D}_{f}^{′} ( y ( s ) , cos γ β + sin λ {e}_{n} ) \qquad Equation 5$$

As will be described in further detail below, filter dependent weights μₙ and the filter vectors eₙ are advantageously selected to provide an exact reconstruction. More particularly, the filter vectors eₙ are advantageously selected to filter the data along one or more sets of filter lines which are defined in relation to virtual planar detectors, while the filter dependent weight(s) μₙ are selected to ensure the reconstruction to be exact in combination or vectors eₙ and weights μₙ.

The backprojector 27 backprojects the filtered data to generate volumetric data f(x) indicative of the object 19 or a region of interest thereof. The backprojection operation can be described as:

$$f ( x ) = \frac{( - 1 )}{2 {π}^{2}} \int \frac{d s}{\vert x - y ( s ) \vert} P ( s , β ( s , x ) ) \qquad Equation 6$$

Note that the backprojection of Equation 6 is applied to the data from both the first 50 and second 50′ circles.

The filter vectors eₙ will now be described in relation to first and second virtual planar detectors each having virtual detector coordinates (uₚₗₐₙₐᵣ, vₚₗₐₙₐᵣ). The first virtual detector 50 is defined in relation to the first circle 50; the second virtual detector is defined in relation to the second circle 50′. For the purposes of the following discussion, the first virtual detector will be assumed to be orthogonal to a line which intersects the source 12 and the center of the first virtual detector (i.e., the first virtual detector will be assumed to be orthogonal to a central ray of the x-ray beam). Moreover, the intersection of a plane containing the first circle 50 will also be assumed to be parallel to the uₚₗₐₙₐᵣ axis of the first virtual detector. The second virtual detector will likewise be assumed to be orthogonal to a line which intersects the source 12′ and the center of the second virtual detector (i.e., the second virtual detector will be assumed to be orthogonal to a central ray of the x-ray beam). The intersection of a plane containing the second circle 50′ will likewise be assumed to be parallel to the uₚₗₐₙₐᵣ axis of the second virtual detector.

The filter vectors eₙ are established so that the differentiated data is filtered along one or more sets of straight filter lines which are defined in relation to the first and second virtual detectors. FIG. 2 depicts a set of filter lines 202 in relation to the first virtual detector 204. Only a single set of filter lines 202 is required, so that the value of N_{F} in Equation 5 above takes the value one (1). The filter lines 202 are parallel to the uₚₗₐₙₐᵣ axis of the first virtual detector 204 and hence to projection 208 of the plane of the first circle 50. The filter dependent weighting μ₁ in Equation 5 above is set to one-half (½). As illustrated, the direction 206 of filtering goes from left to right.

Turning now to the second circle 50′, the number of sets of filter lines and hence the value of N_{F} in Equation 5 above depends on the location on the second virtual detector onto which the object location x is projected. FIGS. 3A and 3B show the second virtual detector 302 as seen from the second circle 50′ for two different, arbitrary source positions s. The curved lines 304 represent the projection of the primary circle 50 onto the second virtual detector 302. The straight line 306, is parallel to the projection of the second circle 50′ onto the second virtual detector 302 and tangential to the projection 304 of the first circle 50 onto the second virtual detector 302.

As can be seen, the projections 304, 306 separate the second virtual detector 302 into regions A, B, C, and D. The number of sets of filter lines N_{F}, the filter dependent weighting μₙ, and the direction eₙ of the filter lines depend on the region of the second virtual detector 302 onto which the object location x is projected.

If the object location x is projected onto region D, the projection data does not need to be filtered or backprojected (i.e., N_{F}=0).

If the object location x is projected onto region A, then three (3) sets of filter lines are required (i.e., N_{F}=3). FIGS. 4A and 4B depict a first set (e.g., n=1) of filter lines 402 at two different, arbitrary positions on the second circle 50′. As shown, the filter lines 402 are parallel to the uₚₗₐₙₐᵣ axis and hence to the projection 306 of the second circle 50′. The filter dependent weight μ₁ is set to one-half (½), and the direction of filtering 404 goes from left to right. FIGS. 5A, 5B, 5C, and 5D depict a second set (e.g., n=2) of filter lines 502 at four (4) different, arbitrary positions on the second circle 50′. As shown, the filter lines 502 are tangential to the projection 304 of the first circle 50, with the point of tangency located to the left of the point onto which the object location x is projected. The filter dependent weight μ₂ is set to one-quarter (¼), and the direction of filtering 504 goes from right to left. FIGS. 6A, 6B, 6C, and 6D depict a third set (e.g., n=3) of filter lines 602 again at four different, arbitrary positions on the second circle 50′. As shown, the filter lines 602 are tangential to the projection 304 first circle 50, with the point of tangency located to the right of the point onto which the object location x is projected. The filter dependent weight μ₃ is set to one-quarter (¼), and the direction of filtering 604 goes from left to right.

If the object location x is projected onto regions B or C, then two (2) sets of filter lines are required (i.e., N_{F}=2). The sets of filter lines shown in FIGS. 5 and 6 are employed. In region B, the filter dependent weight μ is set to one-fourth (¼) for both sets. In region C, the filter dependent weight μ is set to negative one-fourth (−¼) for both sets.

Operation will now be described in relation to FIG. 7.

Scan data for a trajectory which includes the two tilted circles 50, 50′ is acquired at 702.

The scan data obtained from the first 50 and second 50′ circles is differentiated at 704.

The differentiated data is filtered at step 706. As noted above, the number, weighting, and direction of the applied filter(s) advantageously varies as a function of the circle 50, 50′, the source position s, and the object location x to be backprojected. It should be noted that the filter(s) are applied for each of a plurality of source and object locations.

At step 708, the filtered data is backprojected to generate volumetric data.

Human readable images indicative of the volumetric data are displayed at step 710, for example on a monitor associated with the operator console 44, another suitable monitor or display, on film, or otherwise.

Variations are contemplated. For example, the scan of the first circle 50 may be conducted at a relatively higher x-ray dose and the scan of the second circle 50′ conducted a relatively lower dose. Such an implementation is particularly advantageous in connection with cardiac and other applications where it is desirable to reduce artifacts resulting from subject motion. More particularly, such an implementation exploits the fact that the data from the second circle supplies projection data having relatively lower spatial frequency components and is thus somewhat less critical to the quality of the reconstructed image. Note also that cardiac, respiratory, or other motion gating may be applied to the first 50 and/or second 50′ circles, whether prospectively in connection with the scanning operation, retrospectively during reconstruction, or in combination.

In another variation, the results of multiple reconstructions are combined. In a first reconstruction, one of the circles 50, 50′ is treated as the first circle 50, with the other treated as the second circle 50′. In a second reconstruction, the treatment of the circles is reversed (i.e., with the other circle being treated as the first circle, and vice versa). Where the scans of the first 50 and second 50′ circles are conducted using approximately equal doses the results of the reconstructions can be combined by averaging them.

While the filtering operation was described in relation to first and second virtual planar detectors, those of ordinary skill in the art will appreciate that the virtual detectors are not physical detectors but are instead virtual surfaces which serve as constructs for describing the various filter trajectories. Consequently, the filtering operation may also be expressed in relation to other planar or non-planar virtual detectors or surfaces, the physical detector 100 and/or the source 12, or other coordinate systems.

In addition, it is not necessary that the scan of the first circle 50 be conducted temporally prior to the scan of the second circle 50′. Thus, for example, the second circle 50′ may be scanned first. The scanning of the first 50 and second 50′ circles may also be conducted on an interleaved basis. The scanner may also be provided with multiple sets of sources 12 and/or detectors 20, in which case the scanning of the circles may be conducted substantially simultaneously.

The reconstruction need not be carried out contemporaneously with the scan. Accordingly, some or all of the projection data may be stored for subsequent reconstruction and/or manipulation, for example after patient or other subject is no longer in the vicinity of the scanner 10.

Variations on the scanning trajectory are also contemplated. For example, the first 50 and second 50′ circles may have different radii R. Depending on the geometry of the object and the region of interest, it is not necessary that both circles 50, 50′ be tilted with respect to the axis of rotation r. Thus, for example, the plane of one of the circles 50, 50′ may be substantially orthogonal to the axis r. The first 50 and second 50′ circles may also longitudinally offset, particularly in situations where the scanner includes multiple sources 12 and/or detectors 20 and longitudinal motion is provided relative to the object 19.

While the foregoing discussion has focused on an x-ray CT system using an x-ray tube which generates x-radiation from a focal spot, other sources and types of radiation are also contemplated. In one alternative, gamma radiation source(s) and detector(s) are used.

Depending on the desired reconstruction time, matrix size, cost, and other factors, various implementations of the reconstructor 22 are contemplated. For example, one or more of the differentiator 24, filter 26, and backprojector 27 may be implemented via computer readable instructions which, when accessed by a computer processor, cause the computer to carry out the described techniques. In such an implementation, the instructions are stored on a computer readable storage medium which is associated with or otherwise available to the relevant processor. The various functions may also be allocated among multiple computers, computer processors, and/or software routines, operating serially or in parallel. Analogously, some or all of the functionality of the reconstructor 22 may also be implemented in hardware, for example using suitable digital and/or analog circuitry.

The invention has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof.

1. An apparatus comprising:
a differentiator which differentiates computed tomography projection data acquired along a trajectory which includes first and second tilted circles;
a filter which filters the differentiated data, wherein a number and direction of the applied filters varies as a function of an object location which is to be reconstructed;
a backprojector which backprojects the filtered data.

2. The apparatus of claim 1 wherein the differentiator, filter, and backprojector cooperate to perform an exact reconstruction of the projection data.

3. The apparatus of claim 1 wherein the filter filters along a second set of filter lines, and wherein the first set of filter lines are straight lines in relation to a virtual planar detector.

4. The apparatus of claim 3 wherein the filter filters along a second set of filter lines, and wherein the second set of filter lines are straight lines in relation to the virtual planar detector.

5. The apparatus of claim 1 wherein the filter filters data acquired along the first circle in a direction which is parallel to a projection of the first tilted circle on a virtual planar detector.

6. The apparatus of claim 1 wherein the filter applied to data acquired along the second circle varies as a function of a region on a virtual detector onto which the object location is projected.

7. The apparatus of claim 6 wherein virtual detector includes a first region, a second region, a third region, and a fourth region, and wherein the regions are bounded by a projection of the first circle onto the virtual detector and by a line parallel to a projection of the second circle onto the virtual detector.

8. The apparatus of claim 7 wherein the projection of the first circle onto the virtual detector is a curved line and the projection of the second circle onto the virtual detector is a straight line.

9. The apparatus of claim 6 wherein the number and direction of the applied filters varies as a function of the region.

10. The apparatus of claim 1 wherein the filter filters the differentiated data according to the function:
$$P ( s , β ) = {\sum }_{n = 1}^{{N}_{f}} {μ}_{n} {\int }_{- π}^{π} \frac{d γ}{sin γ} {D}_{f}^{′} ( y ( s ) , cos γ β + sin λ {e}_{n} )$$

11. The apparatus of claim 1 wherein the apparatus uses projection data acquired along the first circle to perform a cardiac gated reconstruction.

12. The apparatus of claim 11 wherein projection data acquired along the first circle is acquired at a first relatively higher dose and projection data acquired along the second circle is acquired at a second relatively lower dose.

13. The apparatus of claim 1 further including means for acquiring the computed tomography projection data.

14. A computed tomography method comprising:
differentiating computed tomography projection data acquired along first and second tilted circles;
filtering the differentiated data, wherein a number and direction of the applied filters varies based on a projection of an object location which is to be reconstructed;
backprojecting the filtered data.

15. The method of claim 14 wherein filtering includes filtering the differentiated projection data according to a 1/sin γ filter.

16. The method of claim 14 including filtering data acquired along the second circle along at least a first set of filter lines, wherein the number of sets of projection lines varies as a function of the source position and the object location.

17. (canceled)

18. The method of claim 14 wherein data acquired along the second circle is filtered in a direction which is parallel to the projection of the second circle onto a virtual planar detector.

19. The method of claim 14 wherein data acquired along the second circle is filtered along a plurality of filter lines which are tangential to a projection of the first circle onto a virtual planar detector.

20. The method of claim 14 including weighting the filtered data according to a filter dependent weighting function.

21. (canceled)

22. The method of claim 14 including using projection data acquired along the first and second circles to perform first and second reconstructions and combining the results of the reconstructions.

23. The method of claim 14 wherein the projection data acquired along at least one of the first and second circles is prospectively gated.

24. A computer readable storage medium containing instructions which, when carried out by a computer processor, cause a computer to carry out a computed tomography reconstruction method which includes:
filtering differentiated first cone beam projection data acquired along a first circular trajectory;
filtering differentiated second cone beam projection data acquired along a second circular trajectory; wherein the second circular trajectory is tilted relative to the first circular trajectory;
backprojecting the filtered data to generate volumetric data indicative of an object under examination, wherein the reconstruction is an exact reconstruction.

25. The computer readable storage medium of claim 24 wherein the method further includes differentiating the first cone beam data along parallel rays.

26. The computer readable storage medium of claim 24 wherein filtering the differentiated cone data includes varying a direction of an applied filter based on the location of a projection of an object location which is to be reconstructed.

27. The computer readable storage medium of claim 26 wherein the location of the projection includes the location of the projection on a virtual surface, wherein the projection of the first circle onto the virtual surface forms a curved line, and wherein the projection of the second circle onto the virtual surface forms a straight line.

28. The computer readable storage medium of claim 24 wherein filtering the differentiated cone data includes varying a number of applied filters based on the location of a projection of an object location which is to be reconstructed.

29. (canceled)

30. A method of reconstructing images from data provided by at least a first two dimensional detector, the method comprising:
scanning an object so as to acquire projection data along a trajectory which includes first and second tilted circles with at least a first two dimensional detector and cone beam projections;
reconstructing an exact image of the scanned object with an FBP algorithm.
